(19) United States
(12) Patent Application Publication
(10) Pub. No.: US 2017/0068603 A1
(43) Pub. Date: Mar. 9, 2017

(54) INFORMATION PROCESSING METHOD AND INFORMATION PROCESSING APPARATUS

(71) Applicant: Hitachi, Ltd., Tokyo (JP)

(72) Inventor: Kensuke TAI, Tokyo (JP)

(21) Appl. No.: 15/122,794

(22) PCT Filed: May 12, 2014
(86) PCT No.: PCT/JP2014/062578

§ 371 Date: Aug. 31, 2016

(51) Int. Cl. G06F 11/14; G06F 9/52; G06F 9/48; G06F 17/30

(52) U.S. Cl. CPC G06F 11/1471; G06F 17/30174; G06F 17/30171; G06F 9/522; G06F 9/485; G06F 2201/805; G06F 2201/82; G06F 2201/84

(57) ABSTRACT

Upon executing a job net including a plurality of jobs to be executed in parallel using a shared file, a shared file determination unit determines whether a file used by the jobs is a shared file, a checkpoint management unit sets a checkpoint when the job writes data into a file that was determined to be a shared file, a file copy processing unit creates a replication of the shared file used by the jobs, a process copy processing unit creates a replication of a process of the jobs, and a job execution control unit determines, upon detecting an abnormal state in an active job, a checkpoint from where processing of the job is to be resumed, and resumes the job by using the replication of the shared file and the replication of the process which were created when the checkpoint was set.

### TECHNICAL FIELD

The present invention relates to an information processing method and an information processing apparatus, and in particular is suitable for application to an information processing apparatus which executes a job net including a plurality of jobs to be executed in parallel using a shared file.

### BACKGROUND ART

A job net refers to a collection of one or more jobs in which the order of execution has been designated. Conventionally, if a failure occurred during the execution of a job net, recovery was performed according to a method of returning the files used in the respective jobs to their state prior to the job execution, and re-executing the jobs.

Note that PTL 1 below discloses, with an objective of automating file failure restoration processing which does not require the intervention of an operator and shortening the failure restoration time based on prompt failure recovery processing in a batch-using system using a job net, equipping a job net re-execution apparatus with a re-execution job determination means for determining the jobs that need to be re-executed, a job re-execution means for re-executing the jobs, an execution JCL library for storing the execution job control statement, an access history file for storing file information processed within the job, and a re-execution job management file storing the job names that need to be re-executed during a file failure.

### CITATION LIST

### Patent Literature

PTL 1: Japanese Laid-Open Patent Application Publication No. 2001-229033

### SUMMARY OF THE INVENTION

### Problems to be Solved by the Invention

However, the recovery method from a file failure disclosed in PTL 1 targets a job net in which the jobs are executed serially, and cannot be applied to a job net in which a plurality of jobs are executed in parallel while using the same file.

Thus, if the recovery method disclosed in PTL 1 is applied as the recovery method from a failure of a job net in which a plurality of jobs are executed in parallel while using the same file, it is necessary to re-execute, from the beginning, all of the plurality of jobs that were executed in parallel using the shared file, and there is a problem in that the time required up to the completion of the job net processing will increase.

Moreover, normally, in cases where a job net did not end normally or cases where a failure occurred midway during the execution of a job net, an operator is required to check the jobs configuring the job net or the processing flow of the job net, delete the unnecessary history files that were created during the execution of the job net, find from which point the job net needs to be re-executed, and reactivate the apparatus.

Consequently, not only does the recovery operation from this kind of failure of a job net require time up to the re-execution of the job net, the recovery operation would be a considerable burden and difficult operation for an operator who does not sufficiently understand the contents of the jobs or the job net.

The present invention was devised in view of the foregoing points, and an object of this invention is to propose an information processing method and an information processing apparatus capable of alleviating the operator's workload related to the recovery from a failure in cases where a failure occurs in a plurality of jobs that are executed in parallel using a shared file.

### Means to Solve the Problems

Upon executing a job net including a plurality of jobs to be executed in parallel using a shared file, a shared file determination unit determines whether a file used by the jobs is a shared file, a checkpoint management unit sets a checkpoint when the job writes data into a file that was determined to be a shared file, a file copy processing unit creates a replication of the shared file used by the jobs, a process copy processing unit creates a replication of a process of the jobs, and a job execution control unit determines, upon detecting an abnormal state in an active job, a checkpoint from where processing of the job is to be resumed, and resumes the job by using the replication of the shared file and the replication of the process which were created when the checkpoint, which was determined by the job execution control unit, was set.

### Advantageous Effects of the Invention

According to the present invention, when a failure occurs in a plurality of jobs that are executed in parallel using a shared file, it is possible to alleviate the operator's workload related to the recovery from the failure.

### BRIEF DESCRIPTION OF DRAWINGS

FIG. 1 is a conceptual diagram showing a configuration example of a job net.

FIG. 2 is a conceptual diagram explaining the failure recovery method according to this embodiment.

FIG. 3 is a conceptual diagram explaining the failure recovery method according to this embodiment.

FIG. 4 is a block diagram showing a hardware configuration of the information processing apparatus according to this embodiment.

FIG. 5 is a block diagram showing a logical configuration of the information processing apparatus according to this embodiment.

FIG. 6 is a conceptual diagram showing a schematic configuration of the job definition file.

FIG. 7 is a conceptual diagram explaining a configuration of the management file processing unit according to this embodiment.

FIG. 8 is a conceptual diagram showing a configuration example of the management file according to this embodiment.

FIG. 9 is a conceptual diagram showing a configuration example of the CP information according to this embodiment.

FIG. 10 is a flowchart showing a processing routine of the CP setting processing according to this embodiment.

FIG. 11 is a flowchart showing a processing routine of the job rewind processing according to this embodiment.

FIG. 12 is a flowchart showing a processing routine of the rewind job pre-processing according to this embodiment.

FIG. 13 is a flowchart showing a processing routine of the job rewind common processing according to this embodiment.

### DESCRIPTION OF EMBODIMENTS

An embodiment of the present invention is now explained in detail with reference to the appended drawings.

(1) Overview of Failure Recovery Method According to this Embodiment

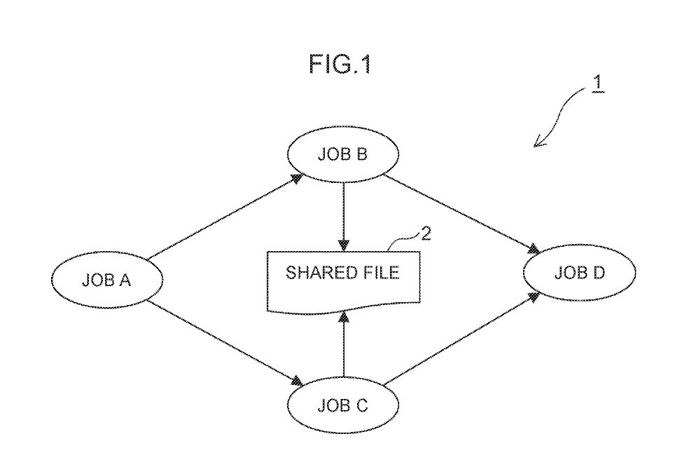

FIG. 1 shows a configuration example of a job net. With this job net 1, after a job A is completed, a job B and a job C are executed in parallel, and subsequently a job D is executed. In the example of FIG. 1, the job B and the job C share a part of a file 2, and processing is advanced while writing data into the file as needed. In the ensuing explanation, a file that is shared by a plurality of jobs is hereinafter referred to as a shared file.

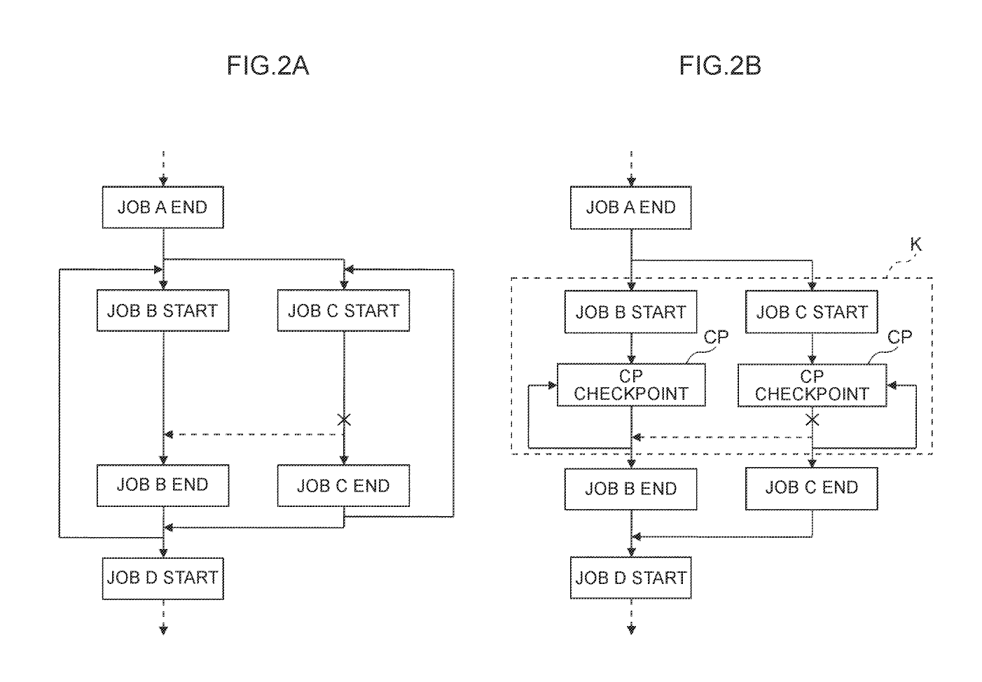

Conventionally, as the failure recovery method in a case where a failure occurs during the execution of the job B or the job C in the job net 1 shown in FIG. 1, as illustrated in FIG. 2A, a method of re-executing the job B and the job C from the beginning after the completion of the job B and the job C has been adopted. Thus, according to this kind of conventional failure recovery method, the failure recovery processing cannot be started unless the job B and the job C are completed, and there was a problem in that a relatively long time is required from failure to recovery.

Meanwhile, with the failure recovery method of this embodiment, as illustrated in FIG. 2B, a checkpoint (this is hereinafter referred to as a “CP”) is sequentially set in a timely manner midway during the execution of the job B and the job C. And if a failure occurs in one of the jobs; for instance, in the job C, the job B and the job C are resumed after returning the processing to a CP that is older than the time that the failure occurred.

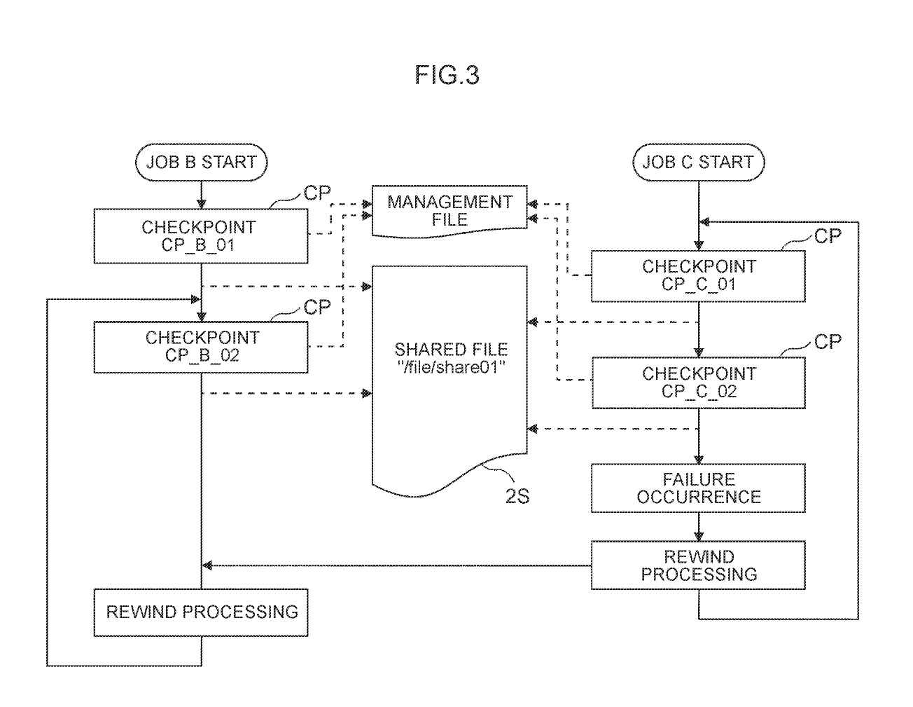

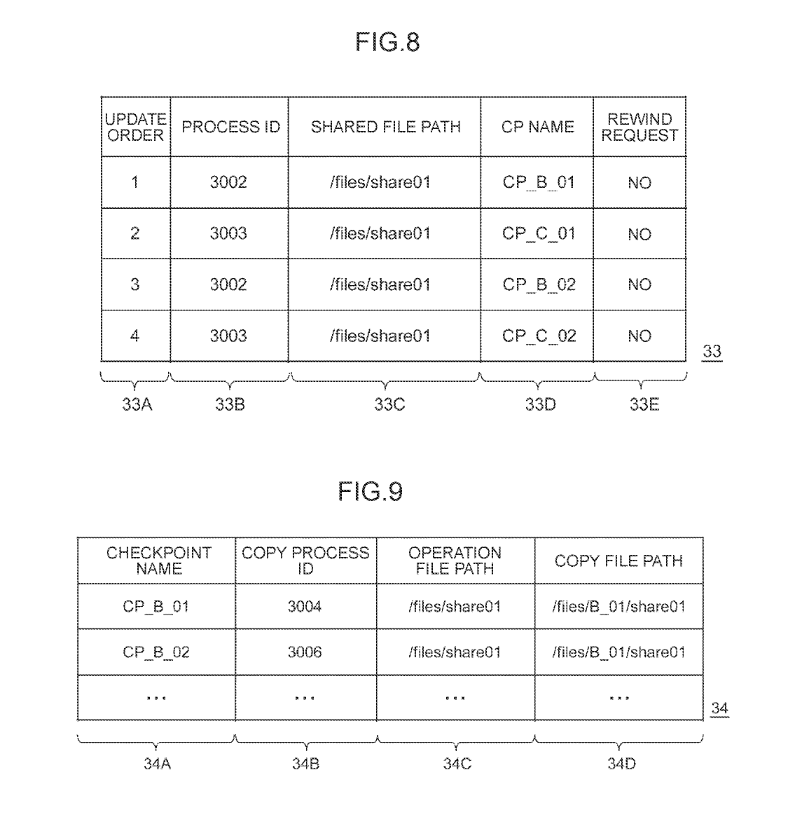

FIG. 3 illustrates the details of the processing framed with a broken line K in FIG. 2. With the failure recovery method of this embodiment, a CP is set upon writing data into a shared file 2S midway during the job B or the job C, or set at an arbitrary timing that is different from the timing described above. A CP is set by registering necessary information in a management file 33 described later with reference to FIG. 8 or in CP information 34 described later with reference to FIG. 9. With the job C in which a failure occurred, CPs are traced back from the time that the failure occurred to the number of CPs designated by the user in advance, and the processing is returned to the corresponding CP. With the job B in which a failure has not occurred, the processing is returned to the oldest CP among the CPs that were set in the job B after the return destination CP of the job C.

As CPs are additionally set, a replication of the respective operation files (including the shared file 2S) at that point in time and a replication of the process at that point in time to be used by the job B or the job C are respectively created and stored. Here, the created process replication is caused to be in a state of temporary suspension. In the ensuing explanation, the replication of the operation file created as described above is referred to as a copy operation file, and the replication of the process created as described above is referred to as a copy process.

And when a failure occurs in the job C using the shared file 2S, with regard to the job C, for example, the processing is returned to the CP that was set when that job last wrote data into the shared file 2S, such as the CP that was set as the return destination of processing by the user in advance (the CP to become the return destination of processing is hereinafter referred to as the “rewind destination CP”). Specifically, with regard to the job C, the processing is resumed by using the respective copy operation files and the copy process that were created when the rewind destination CP was set.

Moreover, with regard to the job B that shares the shared file 2S and is executed in parallel with the job C, with the oldest CP among the CPs that were set in the job B after the rewind destination CP of the job C as the rewind destination CP of the job B, the processing is returned to that rewind destination CP. Specifically, with regard to the job B, the processing is resumed by using the respective copy operation files and the copy process that were created when that rewind destination CP was set.

According to this kind of failure recovery method of this embodiment, it is possible to implement the failure recovery processing of the job in a shorter period in comparison to the conventional failure recovery method described above with reference to FIG. 1, and there is an advantage in that the recovery of the overall job net 1 can be shortened by that much. The information processing apparatus of this embodiment that adopts the foregoing failure recovery method is now explained.

(2) Configuration of Information Processing Apparatus According to this Embodiment

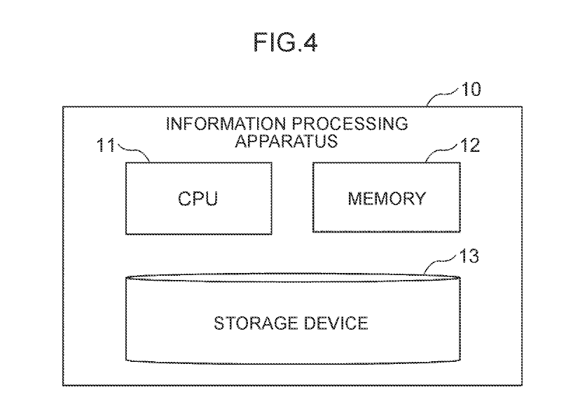

In FIG. 4, reference numeral 10 indicates the overall information processing apparatus of this embodiment. The information processing apparatus 10 is a computer device comprising information processing resources such as a CPU (Central Processing Unit) 11, a memory 12 and a storage device 13, and is configured from a personal computer, a workstation, a mainframe computer or the like.

The CPU 11 is a processor which governs the operational control of the overall information processing apparatus 10. Furthermore, the memory 12 is configured, for example, from a nonvolatile semiconductor memory, and used for retaining various programs and data. The storage device 13 is configured, for example, from a hard disk device, and used for storing programs and data for a long period.

The programs stored in the storage device 13 are read into the memory 12 when the information processing apparatus 10 is activated or when required, and the various types of processing are executed as described later by the CPU 111 executing these programs that were read into the memory 12.

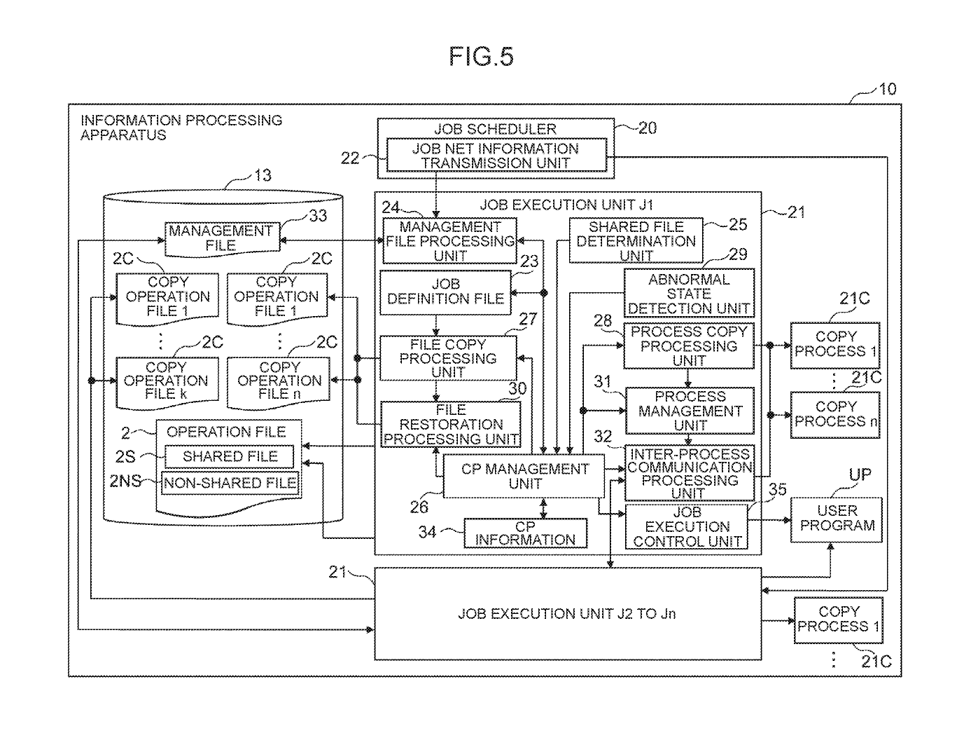

FIG. 5 shows the logical configuration of the information processing apparatus 10. The information processing apparatus 10 according to this embodiment is equipped with a job scheduler 20, and a plurality of jobs execution units 21.

The job scheduler 20 is a program for generating a job net, and is configured by comprising a job net information transmission unit 22. The job net information transmission unit 22 transmits, to each job execution unit 21, various types of information related to the job net (this information is hereinafter referred to as the “job net information”) generated by the job net scheduler 20, and execution instructions of the jobs assigned to the corresponding job execution unit 21.

The job execution units 21 are each a program for executing the job designated by the job net information transmission unit 22 of the job scheduler 20. The job execution unit 21 is configured by comprising a job definition file 23, and a plurality of modules such as a management file processing unit 24, a common file determination unit 25, a CP management unit 26, a file copy processing unit 27, a file restoration processing unit 28, an abnormal state detection unit 29, a process copy processing unit 30, a process management unit 31, an inter-process communication processing unit 32 and a job execution control unit 35.

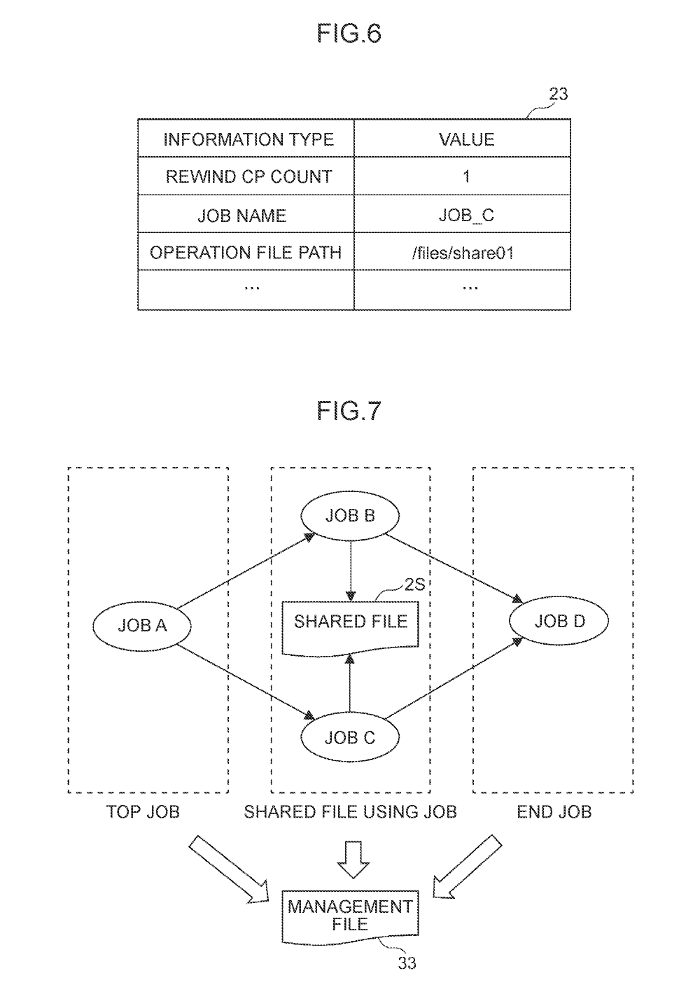

The job definition file 23 is a file in which the contents of the various jobs to be executed by the corresponding job execution unit 21 are defined, and, as illustrated in FIG. 6, stores various types of information such as a job name (“job name” of FIG. 6) of the job to be executed by that job execution unit 21, and a path to the operation file (“operation file path” of FIG. 6) to be used upon executing that job. The job execution unit 21 executes a job for processing a user program UP according to the contents prescribed in the job definition file 23. The setting of to which preceding CP (“rewind CP count” of FIG. 6) the processing should be returned if a failure occurs in a job (“rewind CP count” of FIG. 6) is also registered in the job definition file 23 in advance.

The management file processing unit 24 is a module with a function of managing a management file 33 (FIG. 8) described later. In effect, when the job to be executed by the job execution unit 21 including itself (this job execution unit 21 is hereinafter referred to as the “own job execution unit 21”) is the top job of the job net as shown in FIG. 7 based on the foregoing job net information provided by the job net information transmission unit 22, the management file processing unit 24 creates the management file 33 in the storage device 13 when the corresponding job is started.

Moreover, when the management file processing unit 24 receives instructions from the CP management unit 26 for setting a CP (FIG. 2) (these instructions are hereinafter referred to as the “CP setting instructions”), the management file processing unit 24 registers, in the management file 33, information which is required for setting that point in time as a CP. Furthermore, when the job to be executed by the own job execution unit is the end job of the job net, the management file processing unit 24 deletes the management file 33 that was created regarding that job net after the corresponding job is completed.

Furthermore, when the management file processing unit 24 receives retrieval instructions from the CP management unit 26 designating a key, the management file processing unit 24 retrieves a record (line) including the key designated in the retrieval instructions from the management file 33, and notifies the retrieval result (if there is a corresponding record, then including the contents of that record) to the CP management unit 26.

The shared file determination unit 25 is a module with a function of determining whether the operation file 2 used by the job to be executed by the own job execution unit 21 is a shared file 2S, and notifying the determination result to the CP management unit 26.

Specifically, in cases where the job to be executed by the own job execution unit 21 writes data into the operation file 2, if that operation file 2 is to be locked so that it cannot be accessed by the other job execution units, the shared file determination unit 25 determines that the operation file 2 is a shared file 2S and notifies the determination result to the CP management unit 26. Furthermore, in cases where the job to be executed by the own job execution unit 21 writes data into the operation file 2, if that operation file 2 is not locked, the shared file determination unit 25 determines that the operation file 2 is a non-shared file 2NS (FIG. 5) and notifies the determination result to the CP management unit 26.

The CP management unit 26 is a module with a function for setting CPs and managing the set CPs. In effect, the CP management unit 26 gives CP setting instructions to the management file processing unit 24 when the job to be executed by the own job execution unit 21 writes data into the operation file 2, which was determined by the shared file determination unit 25 as being a shared file 2S, or at an arbitrary timing that is different from the foregoing timing. Consequently, as described above, the required information is registered in the management file 33 by the management file processing unit 24, and that point in time is set as a CP.

Moreover, when a CP is set, the CP management unit 26 gives instructions to the file copy processing unit 27 for creating a replication (copy operation file 2C) of all operation files 2 used by that job based on the contents of that point in time (these instructions are hereinafter referred to as the “file copy instructions”), as well as gives instructions to the process copy processing unit 28 for creating a replication (copy process 21C) of the process of the own job execution unit 21 at that point in time (these instructions are hereinafter referred to as the “process copy instructions”). Furthermore, the CP management unit 26 registers and manages, in the CP information 34 described later with reference to FIG. 8, information related to the respective copy operation files 2C and the copy process 21C created as a result of the foregoing instructions.

In addition, when the CP management unit 26 receives a notice from the abnormal state detection unit 29 to the effect that an abnormal state has been detected as described later (this notice is hereinafter referred to as the “abnormal state detection notice”), the CP management unit 26 is also equipped with a function of resuming the processing by returning the job to be executed by the own job execution unit 21 to the predetermined rewind destination CP set in the job definition file 23.

In effect, when the CP management unit 26 receives an abnormal state detection notice from the abnormal state detection unit 29, the CP management unit 26 causes the management file processing unit 24 to retrieve the rewind destination CP of the own job execution unit 21 from the management file 33 by sending a rewind destination CP detection notice to the management file processing unit 24. When the CP management unit 26 is notified of the predetermined rewind destination CP detected in the foregoing retrieval from the management file processing unit 24, the CP management unit 26 sends the file restoration instructions including information of the notified rewind destination CP to the file restoration processing unit 30, and sends the process restoration instructions including information of the rewind destination CP to the process management unit 31. The job to be executed by the own job execution unit 21 is consequently resumed from the rewind destination CP as described later.

Moreover, the CP management unit 26 instructs the management file processing unit 24 to retrieve the CPs set in the other jobs that are sharing the shared file 2S with the job being executed by the own job execution unit 21. Subsequently, the CP management unit 26 requests the management file processing unit 24 to set, as candidates of the rewind destination of other jobs, all CPs that were created after the rewind destination CP of the job being executed by the own job execution unit 21 among the CPs that were detected in the foregoing retrieval (this request is hereinafter referred to as the “rewind request”). The CP management unit 26 thereafter sends a notice, via the inter-process communication processing unit 32, to the job execution unit 21 that is executing the job sharing the shared file 2C with the job being executed by the own job execution unit 21 to the effect that a failure has occurred (this notice is hereinafter referred to as the “failure occurrence notice”).

Note that, when the CP management unit 26 receives the foregoing failure occurrence notice from another job execution unit 21, the CP management unit 26 makes an inquiry to the management file processing unit 24 regarding the oldest CP among the candidates of the rewind destination CP of the job being executed by the own job execution unit 21 that were set by the other job execution unit 21 in the management file 33. Subsequently, the CP management unit 26 identifies the CP that was notified from the management file processing unit 24 in response to the inquiry as its own rewind destination CP, sends the file restoration instructions including information of the rewind destination CP to the file restoration processing unit 30, and sends the process restoration instructions including information of the rewind destination CP to the process management unit 31. The job to be executed by the own job execution unit 21 is consequently resumed from the rewind destination CP as described later.

The file copy processing unit 27 is a module with a function for creating a replication (copy operation file 2C) of the required operation files 2 under the control of the CP management unit 26. In effect, when the file copy processing unit 27 receives the foregoing file copy instructions from the CP management unit 26, the file copy processing unit 27 retrieves the operation files 2 used by the job that is currently being executed by the own job execution unit 21 from the job definition file 23, and creates the replication of all operation files 2 detected in the foregoing retrieval and stores the created replication in the storage device 13 (FIG. 4).

Moreover, the process copy processing unit 28 is a module with a function for creating a replication (copy process 21C) of the required process under the control of the CP management unit 26. In effect, when the process copy processing unit 28 receives the foregoing process copy instructions from the CP management unit 28, the process copy processing unit 28 creates a replication of the process that is currently being executed by the own job execution unit 21 at that point in time and stores the created replication in the memory 12 (FIG. 4), and sets the created copy process 21C to be in a state of temporary suspension.

The abnormal state detection unit 29 is a module with a function for detecting an abnormal state of the job being executed by the own job execution unit 21. The abnormal state detection unit 29 determines that an abnormality has occurred, for example, when certain processing required more time than the threshold or the data size of the created data is greater than the threshold, and sends an abnormal state detection notice to the CP setting unit 26. Consequently, the file restoration instructions and the process restoration instructions designating the rewind destination CP are provided by the CP management unit 26 to the file restoration processing unit 30 and the process management unit 31 as described above.

The file restoration processing unit 30 is a module with a function for replacing the respective operation files 2 to be used by the job execution unit 21 upon executing the job with the operation files 2 (copy operation files 2C) which were respectively replicated upon setting the rewind destination CP designated in the file restoration instructions provided by the CP management unit 26 in accordance with the file restoration instructions from the CP management unit 26. As described later, the copy process 2C in which the temporarily suspended state has been cancelled by the inter-process communication processing unit 32 uses the replaced copy operation file 2C and executes the resumed processing.

Moreover, the process management unit 31 is a module with a function for replacing the process designated by the process to be executed by the job execution unit 21 with the process (copy process 21C) which was replicated upon setting the rewind destination CP designated in the process restoration instructions provided by the CP management unit 26 in accordance with the process restoration instructions from the CP management unit 26. Specifically, the process management unit 31 gives instructions to the inter-process communication processing unit 32 to resume the processing from the copy process 21C that was created upon setting the rewind destination CP designated in the process restoration instructions from the CP management unit 26.

The inter-process communication processing unit 32 is a module with a function for replacing the processing to be executed by the job execution unit 21 with the copy process 21C designated by the process management unit 31. In effect, when the inter-process communication processing unit 32 receives the foregoing process restoration instructions from the CP management unit 26, the inter-process communication processing unit 32 starts the processing of the copy process 21C by replacing the process to be executed by the own job execution unit 21 with the copy process 21C created in the rewind destination CP, and cancelling the temporarily suspended state of the copy process 21C.

Moreover, the inter-process communication processing unit 32 is also equipped with a function for communicating with the other job execution units 21. Furthermore, when an abnormality occurs in the own job execution unit 21, the inter-process communication processing unit 32 sends the foregoing abnormality occurrence notice to the other job execution units 21 which share any one of the operation files 2 (shared files 2S) with the job being executed by the own job execution unit 21 in accordance with the instructions of the CP management unit 26.

FIG. 8 shows a configuration example of the management file 33 that is created in the storage device 13 by the management file processing unit 24. The management file 33 is a file that is used for managing the CPs set by the CP management unit 26, and is shared by all job execution units 21. The management file 33 has a table structure configured from, as shown in FIG. 8, an update order column 33A, a process ID column 33B, a shared file path column 33C, a CP name column 33D and a rewind request yes/no column 33E. In the management file 33, one record (line) corresponds to one CP.

The update order column 33A stores the order in which the corresponding CP was set, and the process ID column 33B stores the identifier (process ID) of the process that was being executed by the corresponding job execution unit 21 at the time that the corresponding CP was set. Furthermore, the shared file path column 33C stores the path to the operation file 2 (shared file 2C) in which data was written therein at that time, and the CP name column 33D stores the name of the CP (CP name) that is automatically assigned to the corresponding CP.

Furthermore, the rewind request yes/no column 33E stores information indicating whether the corresponding CP has been set as a candidate of the rewind destination CP of another job execution unit 21 by the job execution unit 21 in which an abnormality occurred as described above (“Yes” in cases where the corresponding CP has been set as a candidate of the rewind destination CP, and “No” if the corresponding CP has not been set as a candidate of the rewind destination CP).

Meanwhile, FIG. 9 shows the checkpoint information 34 that is created in the memory 12 (FIG. 4) by the CP management unit 26. The checkpoint information 34 is information that is used for managing the correspondence relation of the CPs, and the copy operation file 2C and the copy process 21C, and is created for each job. The checkpoint information 34 has a table structure configured from, as shown in FIG. 9, a checkpoint name column 34A, a copy process ID column 34B, an operation file path column 34C and a copy operation file path column 34D. With the checkpoint information 34, one line corresponds to one CP.

The CP name column 34A stores the CP name of each CP that was set, and the copy process ID column 34B stores the process ID of the process that was being executed by the job execution unit 21 when the corresponding CP was set. Furthermore, the operation file path column 34C stores the path to all operation files 2 to be used in the process (job), and the copy operation file path column 34D stores the path to the copy operation file 2C of each operation file 2 that was created when the corresponding CP was set.

The job execution control unit 35 is a module for controlling the execution of the user program UP. Specifically, the job execution control unit 35 activates the user program UP, waits for the completion of the user program UP, and forces a shutdown of the user program UP.

(3) Various Types of Processing Performed by Job Execution Unit

The specific processing contents of the various types of processing that are executed by the job execution unit 21 are now explained. In the ensuing explanation, while the processing entity of the various types of processing is explained as a module, in effect, it goes without saying that the processing is executed by the CPU 11 (FIG. 4) based on the module.

(3-1) Shared File Determination Processing

The shared file determination processing unit 25 starts the shared file determination processing at the timing that the job execution unit 21 is to write data into the operation file 2 upon executing the job, and foremost determines whether the own job execution unit 21 locked the operation file 2 so that it cannot be accessed by the other job execution units 21.

When it is determined that the operation file 2 has not been locked, this means that the operation file 2 is not a shared file. Consequently, the shared file determination unit 25 ends the shared file determination processing.

Meanwhile, when it is determined that the operation file 2 has been locked, this means that the operation file 2 is a shared file. Consequently, the shared file determination unit 25 sends, to the CP management unit 26, a notice to the effect that the operation file 2 of the data write destination is a (this notice is hereinafter referred to as the “shared file write notice”), and then ends the shared file determination processing.

(3-2) CP Setting Processing

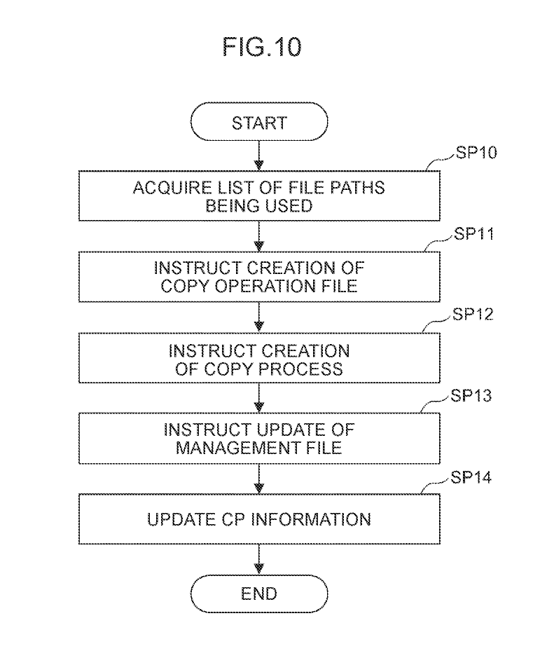

FIG. 10 shows the processing routine of the CP setting processing to be executed by the CP management unit 26 that received the shared file write notice from the shared file determination unit 25 in the foregoing shared file determination processing. The CP management unit 26 sets the CP of that point in time according to the processing routine shown in FIG. 10.

In effect, when the CP management unit 26 receives the shared file write notice, the CP management unit 26 starts the CP setting processing, and foremost acquires, from the job definition file 23, the path to all operation files 2 that are being used by the own job execution unit 21 at that point in time (these paths are hereinafter each referred to as the “file path”) (SP10).

Next, the CP management unit 26 gives instructions (file copy instructions) to the file copy processing unit 27 to create the replication (copy operation file 2C) of each operation file 2 that is access through each file path acquired in step SP10 (SP11). Consequently, the file copy processing unit 27 creates, in the storage device 13, the replication of each operation file 2 designated in the file copy instructions according to the file copy instructions.

Moreover, the CP management unit 26 gives instructions (process copy instructions) to the process copy processing unit 28 to create the replication (copy process 21C) of the process being executed by the own job execution unit 21 at that point in time (SP12). Consequently, the process copy processing unit 28 creates, in the memory 12 or the storage device 13, the replication of the process designated in the process copy instructions according to the process copy instructions, and sets the created copy process 2C to a state of temporary suspension.

Next, the CP management unit 26 gives instructions (CP registration instructions) to the management file processing unit 24 to set a CP (SP13). Consequently, the management file processing unit 24 sets that processing point as a CP by registering the required information in the management file 33 according to the CP registration instructions.

Furthermore, the CP management unit 26 newly registers, in the CP information 34 (FIG. 9) stored in the memory 12, the CP name of the CP that was set, copy process ID of the copy process 21C, path to all operation files 2 to be used by the own job execution unit 21, and path to the copy operation files 2C of these operation files 2 (SP14), and thereafter ends the CP setting processing.

Note that the CP management unit 26 sets a CP as appropriate at an arbitrary timing separate from the case of receiving the shared file write notice from the shared file determination unit 25. In the foregoing case, the CP management unit 26 does not register the created CP in the management file 33, and manages the CP only by registering the required information related to the CP in the CP information 34.

(3-3) Job Rewind Processing

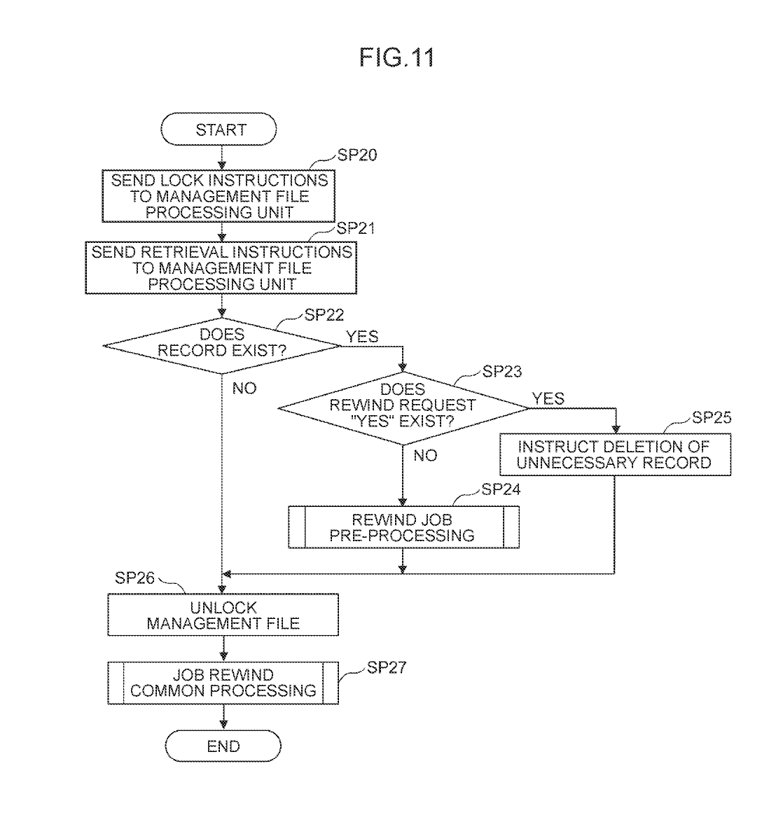

Meanwhile, FIG. 11 shows the processing routine of the job rewind processing that is executed by the CP management unit 26 that received an abnormal state detection notice from the abnormal state detection unit 29, or received a notice (failure occurrence notice) to the effect that a failure has occurred from another job execution unit 21 via the inter-process communication processing unit 32.

When the CP management unit 26 receives an abnormal state detection notice from the abnormal state detection unit 29 or a failure occurrence notice from another job execution unit 21, the CP management unit 26 gives instructions to the management file processing unit 24 to lock the management file 33 so that it cannot be accessed by other job execution units 21 (these instructions are hereinafter referred to as the “lock instructions”) (SP20). Consequently, the management file processing unit 24 locks the management file 33 according to the lock instructions so that it cannot be access by other job execution units 21.

Next, the CP management unit 26 gives retrieval instructions to the management file processing unit 24 to retrieve the management file 33 with the process ID of the process that is currently being executed by the own job execution unit 21 as the key (SP21). Consequently, the management file processing unit 24 receives a record from the management file 33 (FIG. 8) in which the designated process ID is stored in the process ID column 33B (FIG. 8) according to the retrieval instructions, and notifies the retrieval result (if such a record exists, then including information of that record) to the CP management unit 26.

Next, the CP management unit 26 determines whether the record, in which the process ID of the process that is currently being executed by the own job execution unit 21 is stored in the process ID column 33, exists in the management file 33 based on the foregoing retrieval result notified from the management file processing unit 24 in step SP21 (SP22).

To obtain a negative result in this determination means that the shared file 2S is not being used in the job being executed by the own job execution unit 21 at that time. Consequently, the CP management unit 26 proceeds to step SP26.

Meanwhile, to obtain a positive result in the determination of step SP22 means that the job being executed by the own job execution unit 21 at that time is using the shared file 2S. Consequently, the CP management unit 26 determines whether there is a record among the records of the management file 33 in which the process ID stored in the process ID column 33B coincides with one's own process ID and in which “Yes” is stored in the rewind request yes/no column 33E (FIG. 8) based on the retrieval result of the management file processing unit 24 acquired in step SP21 (SP23).

To obtain a negative result in this determination means that a failure has occurred in the job being executed by the own job execution unit 21. Consequently, the CP management unit 26 executes the rewind job pre-processing of identifying the rewind destination CP of another job that is sharing the operation file 2 (shared file 2S) with the job being executed by the own job execution unit 21 (SP24).

This rewind job pre-processing, as described later, is processing of deleting, from the management file 33, records of CPs that are newer than the rewind destination CP of the job being executed by the own job execution unit 21 on the one hand, and setting, in the management file 33, candidates of the rewind destination CP of the jobs that are being executed by the other job execution units 21 on the other hand. In other words, in this embodiment, the job execution unit 21 in which a failure occurred sets the candidates of the rewind destination CP of the other jobs sharing the operation file 2 (shared file 2S) with the job being executed by the own job execution unit 21.

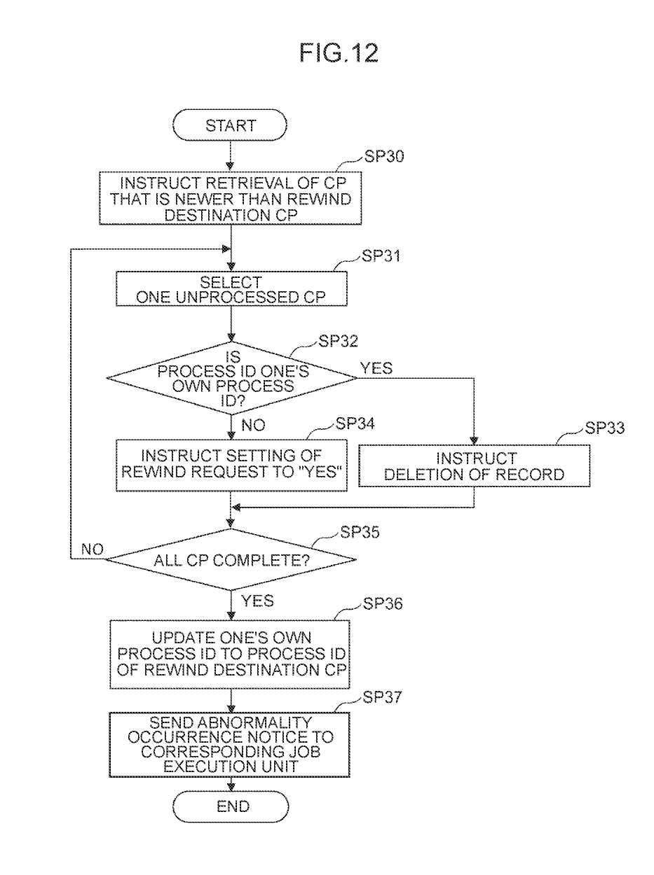

Meanwhile, to obtain a positive result in the determination of step SP23 means that a failure has occurred in another job that is sharing the operation file 2 with the job being executed by the own job execution unit 21. In the foregoing case, the job execution unit 21 executing the job in which a failure has occurred has already set, in the management file 33, the candidates of the rewind destination CP of the own job execution unit 21 (refer to step SP37 of FIG. 12). Consequently, the CP management unit 26 identifies and sets one rewind destination CP of the job being executed by the own job execution unit by deleting, from the management file 33, information of records other than the record with the smallest update order among the records in which “Yes” is stored in the rewind request yes/no column 33E of the management file 33 based on the retrieval result of the management file processing unit 24 acquired in step SP21 (SP25).

Next, the CP management unit 26 unlocks the management file 33 by giving instructions to the management file processing unit 24 to unlock the management file 33 (SP26), and thereafter executes the job rewind common processing of actually returning the processing of the own job execution unit 21 or, as needed, the processing of other job execution units 21 to the rewind destination CP (SP27). The CP management unit 26 thereafter ends the job rewind processing.

(3-4) Rewind Job Pre-Processing

FIG. 12 shows the specific processing contents of the rewind job pre-processing to be executed by the CP management unit 26 in step SP24 of the job rewind processing. The rewind destination job pre-processing is processing to be executed by the CP management unit 26 of the job execution unit 21 that is executing the job in which a failure has occurred as described above. The CP management unit 26 sets the rewind destination CP of the job being executed by the job execution unit 21 and the jobs being executed by the other job execution units 21 according to the processing routine shown in FIG. 12.

When the CP management unit 26 proceeds to step SP24 of the job rewind processing, the CP management unit 26 starts the rewind job pre-processing shown in FIG. 12, and foremost gives retrieval instructions to the management file processing unit 24 to retrieve CPs that are newer than the rewind destination CP of the job being executed by the own job execution unit 21 (SP30). Consequently, the management file processing unit 24 retrieves the corresponding CP from the management file 33 according to the retrieval instructions, and notifies the retrieval result (including information of each corresponding record) to the CP management unit 26.

Next, the CP management unit 26 selects one CP, in which the processing of step SP32 to step SP35 has not yet been performed, among the CPs that are newer than the rewind destination CP of the job being executed by the own job execution unit 21 which were detected by the management file processing unit 24 (SP31).

Next, the CP management unit 26 determines whether the process ID 33B stored in the process ID column 33B (FIG. 8) of the record of the management file 33 corresponding to the CP selected in step SP31 is the process ID of the process being executed by the own job execution unit 21 based on the retrieval result notified by the management file processing unit 24 in step SP30 (SP32).

To obtain a positive result in this determination means that the CP selected in step SP31 is a CP that was set after the rewind destination CP of the corresponding job among the CPs set in the job being executed by the own job execution unit 21. Consequently, the CP management unit 26 gives instructions to the management file processing unit 24 to delete the record of that CP from the management file 33 so as to set the rewind destination CP as the rewind destination of the processing (SP33), and thereafter proceeds step SP35.

Meanwhile, to obtain a negative result in the determination of step SP32 means that the CP selected in step SP31 is a CP that was set in another job sharing the shared file 2S with the job being executed by the own job execution unit 21 and a CP that was set after the rewind destination CP of the job being executed by the own job execution unit 21 (that is, a CP that may become a candidate of the rewind destination CP of the other job). Consequently, the CP management unit 26 sends a rewind request to the management file processing unit 24 to set “Yes” as the information stored in the rewind request yes/no column 33E (FIG. 8) of the record corresponding to that CP in the management file 33 (SP34).

Thereafter, the CP management unit 26 determines whether the processing of step SP32 to step SP34 is complete regarding all CPs that are newer than the rewind destination CP of the own job execution unit 21 detected in the retrieval processing of the management file processing unit 24 in step SP30 (SP35).

The CP management unit 26 returns to step SP31 upon obtaining a negative result in this determination, and thereafter repeats the processing of step SP31 to step SP35 while sequentially switching the CP selected in step SP31 to another unprocessed CP.

When the CP management unit 26 eventually obtains a positive result in step SP35 as a result of the processing of step SP32 to step SP35 being completed regarding all CPs detected in the retrieval processing of the management file processing unit 24 in step SP30, the CP management unit 26 makes an inquiry to the management file processing unit 24 regarding the process ID registered in the management file 33 by being associated with the rewind destination CP of the own job execution unit 21, and updates the process ID that was consequently notified by the management file processing unit 24 as the process ID of the process to be executed by the own job execution unit 21 (SP36).

Furthermore, the CP management unit 26 gives instructions to the inter-process communication processing unit 32 to send a failure occurrence notice to the job execution unit 21 that is executing the process of the process ID stored in the process ID column 33B of the record corresponding to the CP which sent a rewind request to the management file processing unit 24 to update the information stored in the rewind request yes/no column 33E to “Yes” in step SP34 (SP37). The CP management unit 26 thereafter ends the rewind job pre-processing.

Note that, while there may be multiple CPs in which the information stored in the rewind request yes/no column 33E is updated to “Yes” in step SP34, in the foregoing case, since information of records other than the record with the smallest update order among the records in which “Yes” is stored in the rewind request yes/no column 33E of the management file 33 is deleted in step SP25 of the job rewind processing as described above with reference to FIG. 11, the job execution unit 21 that received the failure occurrence notice sent from the inter-process communication processing unit 32 in step SP37 will consequently return the processing to the CP that was set last.

(3-5) Job Rewind Common Processing

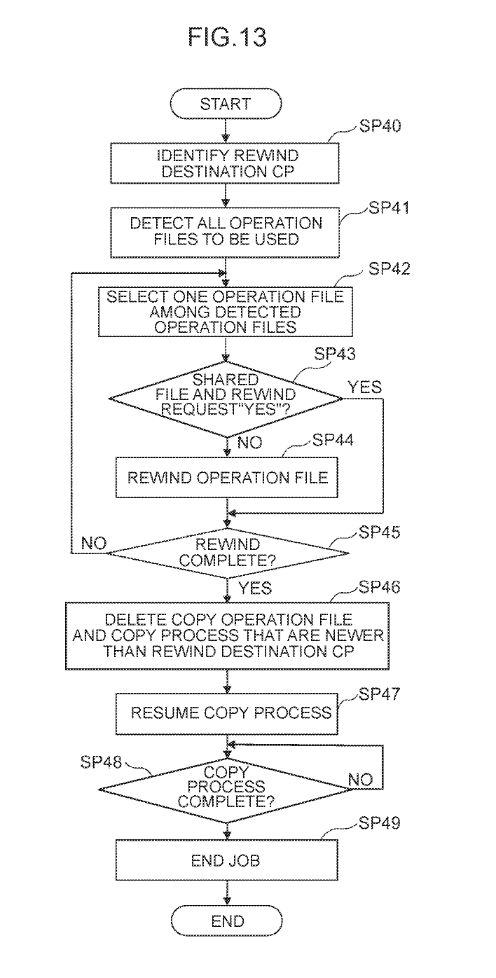

FIG. 13 shows the specific processing contents of the job rewind common processing to be executed by the CP management unit 26 in step SP27 of the job rewind processing (FIG. 11). The CP management unit 26 actually rewinds the job according to the processing routine shown in FIG. 13.

In effect, when the CP management unit 26 proceeds to step SP27 of the job rewind processing, the CP management unit 26 starts the job rewind common processing shown in FIG. 13, and foremost identifies the rewind destination CP of the job to be executed by the own job execution unit 21 (SP40).

For example, when the CP management unit 26 proceeds to step SP27 after going through step SP22, step SP23, step SP24 and step SP26 in the job rewind processing, the CP management unit 26 recognizes that a failure has occurred in the job being executed by the own job execution unit 21 and that the job is sharing the operation file 2 with a job being executed by another job execution unit 21. Thus, in the foregoing case, the CP management unit 26 identifies the rewind destination CP that was pre-set by the user as the rewind destination of the job being executed by the own job execution unit 21.

Moreover, when the CP management unit 26 proceeds to step SP27 after going through step SP22, step SP23, step SP25 and step SP26 in the job rewind processing, the CP management unit 26 recognizes that a failure has occurred in another job execution unit 21 that is sharing the operation file 2 (shared file 2S) with the job being executed by the own job execution unit 21. Thus, in the foregoing case, the CP management unit 26 instructs the management file processing unit 24 to retrieve the CP name stored in the CP name column 33D (FIG. 8) of the record in which the process ID of the process being executed by the own job execution unit 21 is stored in the process ID column 33B (FIG. 8) and in which “Yes” is stored in the rewind request column 33E (FIG. 8) in the management file 33. Subsequently, the CP management unit 26 identifies the CP assigned with the CP name detected in the retrieval and notified by the management file processing unit 24 as the rewind destination CP of the job being executed by the own job execution unit 21.

Furthermore, when the CP management unit 26 proceeds to step SP27 after obtaining a negative result in step SP22 and thereafter going through step SP26 of the job rewind processing (FIG. 11), the CP management unit 26 recognizes that the job being executed by the own job execution unit 21 is not sharing the operation file 2 with the jobs being executed by the other job execution units 21, and that a failure has occurred in the job being executed by the own job execution unit 21. Thus, in the foregoing case, the CP management unit 26 refers to the CP information 34 stored in the memory 12, and identifies, as the rewind destination CP, the newest CP that was set before the point in which the failure occurred among the CPs created at an arbitrary timing that is different from the timing that the job being executed by the own job execution unit 21 is to write data into the shared file 2S.

Next, the CP management unit 26 detects all paths (operation file paths) to the respective operation files 2 to be used by the job being executed by the own job execution unit 21 by retrieving the CP information 34 (FIG. 9) from the memory 12 (FIG. 4) with the CP name of the rewind destination CP identified in step SP40 as the key (SP41).

Next, the CP management unit 26 selects the path to one operation file 2 among the paths to the operation files 2 detected in step SP41, and makes an inquiry to the rewind destination CP regarding whether the path to that operation file is stored in the shared file path column 33C (FIG. 8) of any one of the records of the management file 33 and whether “Yes” is stored in the rewind request column 33E of that record with the path to the selected operation file 2 as the key (SP43).

When the reply of the management file processing unit 24 to the inquiry is a negative result, the CP management unit 26 retrieves the path to the replication (copy operation file 2C) of the operation file 2 selected in step SP42 from the CP information 34, and rewinds the operation file 2 to be used by the corresponding job to the copy operation file 2C by replacing the path to the operation file 2 to be used by the job being executed by the own job execution unit 21 with the path to the copy operation file 2C detected in the retrieval (SP44). The CP management unit 26 thereafter proceeds to step SP45.

Meanwhile, when the reply of the management file processing unit 24 to the inquiry of step SP43 is a positive result, this means that the operation file 2 is a shared file 2S in which data was written by the job at the time that the rewind destination CP of the job being executed by the own job execution unit 21 was set. In the foregoing case, the shared file 2S will be rewound to the state of the rewind destination CP of the job as a result of the job in which a failure occurred executing step SP44. Consequently, in the foregoing case, the CP management unit 26 proceeds to step SP45 and determines whether the processing of step SP43 and step SP44 is complete regarding the paths of all operation files 2 detected in step SP41 (SP45).

The CP management unit 26 returns to step SP42 upon obtaining a negative result in this determination, and thereafter repeats the processing of step SP42 to step SP45 while sequentially switching the path of the operation file 2 selected in step SP42 to a path of an unprocessed operation file 2.

When the CP management unit 26 eventually obtains a positive result in step SP45 as a result of rewinding all operation files 2 in which their paths were detected in step SP41 to the state of the rewind destination CP of the job being executed by the own job execution unit 21, the CP management unit 26 deletes the copy operation file 2C and the copy process 21C which were created when the CPs, which were set later the rewind destination CP of the job being executed by the own job execution unit 21, were set (SP46).

Furthermore, the CP management unit 26 acquires, from the CP information 34, the process ID of the copy process that was created when the rewind destination CP was set, identifies the corresponding copy process based on the acquired process ID, and resumes the job to be executed by the own job execution unit 21 by cancelling the temporarily suspended state of the copy process (SP47).

Thereafter, the CP management unit 26 waits for the copy process resumed in step SP47 to be completed (SP48), and, when the copy process is eventually completed, ends the job being executed by the own job execution unit 21 (SP49), and thereafter ends the job rewind common processing.

(4) Effect of this Embodiment

Accordingly, with the information processing apparatus 10 of this embodiment, the point that each job writes data into the shared file 2S is set as a CP, replications of the respective operation files 2 and the process at the time that the CP was set are created, and, when a failure occurs in a job, an appropriate CP is selected as the rewind destination CP among the CPs that were set before the time that the failure occurred, and the job is resumed by using the replications of the respective operation files 2 and the process that were created at the time that the rewind destination CP was set.

Thus, according to the information processing apparatus 10, even if a job net does not end normally or a failure occurs midway during the execution of a job net, there is no need for the operator to perform a series of recovery work such as checking the jobs configuring the job net or the processing flow of the job net, deleting the unnecessary history files created during the execution of the job net, finding from where the job net should be re-executed, and reactivating the apparatus, and it is thereby possible to alleviate the operator's workload related to the recovery from a failure in the job net.

Moreover, according to the information processing apparatus 10, even in cases where a failure occurs in any one of the plurality of jobs that are performed in parallel by using the shared file 2S, it is not necessary to re-execute these jobs from the beginning, it is possible to shorten the time required for the recovery from a failure in the job net in comparison to the case of re-executing all of the jobs from the beginning, and consequently shorten the time required up to the completion of the job net processing.

(5) Other Embodiments

In the embodiment described above, a case of configuring the information processing apparatus 9 as illustrated in FIG. 5 was explained. However, the present invention is not limited thereto, and, for example, a certain module group among the plurality of modules described above with reference to FIG. 5 may also be configured as a single module, and various other configurations may be broadly applied as the logical configuration of the information processing apparatus 10.

Moreover, in the embodiment described above, a case of managing information related to the CPs separately as the management file 33 described above with reference to FIG. 8 and the CP information 34 described above with reference to FIG. 9 was explained. However, the present invention is not limited thereto, and the foregoing information may also be collectively managed as one piece of information.

Furthermore, in the embodiment described above, a case of managing the management file 33 by storing it in the storage device 13, and managing the CP information 34 created by the individual job execution units 21 by storing it in the memory 12 was explained. However, the present invention is not limited thereto, and the management file 33 may also be managed by being stored in the memory 12, or the CP information 34 may also be managed by being stored in the storage device 13. However, with regard to the CP information 34, better accessibility and faster processing can be expected by storing the CP information 34 in the memory 12.

Furthermore, in the embodiment described above, a case of adopting a software configuration of configuring the job execution units (job execution units 21) which respectively execute different jobs, the shared file determination unit 25 which determines whether the operation file 2 used by the job being executed by the own job execution unit 21 is a shared file 2S, the CP management unit 26 which sets a CP upon the job writing data into the operation file 2 that was determined by the determination unit as being a shared file 2S, a file copy processing unit 27 which creates a replication of all operation files 2 used by that job when the CP is set, the process copy processing unit 28 which creates a replication of the process of the own job execution unit 21 when the CP is set, the abnormal state detection unit 29 which detects an abnormal state that occurred in the job, the communication processing unit (inter-process communication processing unit) which sends an abnormality occurrence notice to the other job execution units (job execution units 21) that are executing jobs in parallel by using the shared file 2S when the abnormal state detection unit 29 detects an abnormal state, and the job execution control unit 35 which controls the execution of the user program UP via software was explained. However, the present invention is not limited thereto, and the foregoing software and modules may also be configured as dedicated hardware.

Furthermore, in the embodiment described above, a case of adopting a user setting where the CP that was set last is used as the rewind destination CP of the job in which a failure occurred was explained. However, the present invention is not limited thereto, and, for instance, a CP other than the CP that was set last, such as the CP that was set second to last or third to last, may also be used as the rewind destination CP of the job. For example, with a job using the shared file 2S, in order to prevent the processing from being rewound to the CP that was set at an arbitrary timing other than the CP that were set when that job wrote data in to the shared file 2S, rather than simply using the CP that was set last as the rewind destination CP, for instance, the CP that was set when that job last wrote data into the shared file 2S may also be used as the rewind destination CP.

### REFERENCE SIGNS LIST

1: job net

2: operation file

2S: shared file

2C: copy operation file

10: information processing apparatus

11: CPU

12: memory

13: storage device

20: job scheduler

21: job execution unit

21C: copy process

23: job definition file

24: management file processing unit

25: shared file determination unit

26: CP management unit

27: file copy processing unit

28: process copy processing unit

29: abnormal state detection unit

30: file restoration processing unit

31: process management unit

32: inter-process communication processing unit

33: management file

34: CP information

35: job execution control unit

CP: checkpoint

1. An information processing method in an information processing apparatus which executes a job net including a plurality of jobs to be executed in parallel using a shared file, wherein:
a shared file determination unit determines whether a file used by the jobs is a shared file;
a checkpoint management unit sets a checkpoint when the job writes data into a file that was determined to be a shared file, and a file copy processing unit creates a replication of the shared file used by the jobs;
a process copy processing unit creates a replication of a process of the jobs; and
a job execution control unit determines, upon detecting an abnormal state in an active job, a checkpoint from where processing of the job is to be resumed, and resumes the job by using the replication of the shared file and the replication of the process which were created when the checkpoint, which was determined by the job execution control unit, was set.

2. The information processing method according to claim 1,
wherein the shared file determination unit:
determines whether the file is a shared file based on whether the file is to be locked so that the file cannot be accessed by other jobs when the job is to access the file.

3. The information processing method according to claim 2,
wherein the checkpoint management unit:
registers, in a management file, a process ID of the job for which a checkpoint is to be set upon setting a checkpoint by associating the process ID with the checkpoint; and
creates the management file when the job to be executed is a first job to be activated in the job net, and deletes the management file when the job to be executed is a last job to be completed in the job net after the job is completed.

4. The information processing method according to claim 3,
wherein, when an abnormal state is detected in an active job, the checkpoint management unit causes the job execution unit to resume the job, with the determined checkpoint as the checkpoint for resuming the job, by using the replication of the file and the replication of the process which were created when the checkpoint was set; and
wherein, when an abnormal state arises in another job, the checkpoint management unit causes the job execution unit to resume the job, with an oldest checkpoint among the checkpoints which were set in the jobs later than the checkpoint for resuming the other job, as the checkpoint for resuming the job.

5. The information processing method according to claim 4,
wherein, when an abnormal state arises in another job, the checkpoint management unit causes the job execution unit to resume the job by using a replication of the shared file, which was created when the checkpoint to be used upon resuming the other job was set, with regard to a shared file that is being shared with the other job.

6. An information processing apparatus which executes a job net including a plurality of jobs to be executed in parallel using a shared file, comprising:
a shared file determination unit which determines whether a file used by an active job is a shared file to be shared with another job;
a checkpoint management unit which sets a checkpoint when the job writes data into a file that was determined to be the shared file by the shared file determination unit;
a file copy processing unit which creates a replication of the shared file used by the jobs when the checkpoint is set; and
a process copy processing unit which creates a replication of a process of the jobs when the checkpoint is set; and
wherein the checkpoint management unit comprises a job execution control unit which identifies a checkpoint for resuming processing of the job when an abnormal state of an active job is detected, and resumes the job from the identified checkpoint by using the replication of the shared file and the replication of the process which were created when the checkpoint was set.

7. The information processing apparatus according to claim 6,
wherein the shared file determination unit:
determines whether the file is a shared file based on whether the file is to be locked so that the file cannot be accessed by other jobs when the job is to access the file.

8. The information processing apparatus according to claim 7, further comprising:
a management file processing unit which:
creates a management file for storing checkpoint information when the job to be executed by the job execution unit is a first job to be executed in the job net;
receives checkpoint information set by the checkpoint management unit and stores the checkpoint information in the management file; and
deletes the management file storing the checkpoint information when the job to be executed by the job execution unit is a last job to be completed in the job net.

9. The information processing apparatus according to claim 7,
wherein the checkpoint management unit:
when an abnormal state is detected in an active job, causes the job execution unit to resume the job, with a predetermined checkpoint as the checkpoint of a return destination of processing, by using the replication of the file and the replication of the process which were created when the checkpoint was set; and
wherein, when an abnormality occurrence notice of another job is received from another job execution unit, causes the job execution unit to resume the job, with an oldest checkpoint among the checkpoints which were set later than the return destination checkpoint of processing of the other job executed by the other job execution unit, as the checkpoint of a return destination of processing, by using the replication of the file and the replication of the process which were created when the oldest checkpoint was set.

10. The information processing apparatus according to claim 9,
wherein the checkpoint management unit:
when an abnormality occurrence notice of another job is received from another job execution unit, causes the job execution unit to resume the job by using a replication of the shared file, which was created when the checkpoint of the return destination of processing of the job executed by the other job execution unit was set, with regard to the shared file to be shared with the job executed by the other job execution unit.
